(19) United States
(12) Patent Application Publication
(10) Pub. No.: US 2025/0170719 A1
(43) Pub. Date: May 29, 2025

(54) METHOD, APPARATUS AND PROGRAM FOR COLLISION DETECTION BRAKING CONTROL IN SERVING ROBOT

(71) Applicant: RGT Inc., Seoul (KR)

(72) Inventor: Hojeong JEONG, Daejeon (KR)

(73) Assignee: RGT Inc., Seoul (KR)

(21) Appl. No.: 18/952,867

(22) Filed: Nov. 19, 2024

(30) Foreign Application Priority Data
Nov. 29, 2023 (KR) 10-2023-0169562

(51) Int. Cl. B25J 9/16; B25J 5/00; B25J 11/00

(52) U.S. Cl. CPC B25J 9/1676; B25J 5/007; B25J 9/1674; B25J 11/0045

(57) ABSTRACT

A method of collision detection braking control in a serving robot according to various embodiments of the present invention is disclosed. The method includes: acquiring sensitivity and a braking time related to collision detection of a serving robot; determining collision detection reference values for each movement state based on the sensitivity; monitoring the movement state of the serving robot and a motor current value of the serving robot; and controlling the serving robot to brake for the braking time when the motor current value exceeds the collision detection reference value corresponding to the movement state.

### CROSS-REFERENCE TO RELATED APPLICATION

This application claims priority to and the benefit of Korean Patent Application No. 10-2023-0169562, filed on Nov. 29, 2023, the disclosure of which is incorporated herein by reference in its entirety.

### BACKGROUND

### 1. Field of the Invention

The present invention relates to a method, apparatus, and program for collision detection braking control in a serving robot, and more particularly, to a method, apparatus, and program for detecting a collision of a serving robot based on a current value of a motor provided in the serving robot and controlling the serving robot to brake.

### 2. Discussion of Related Art

Serving unit providing objects such as drinks or food to customers in places such as restaurants. Recently, serving robots, etc., have been developed and are being used to serve instead of waiters or waitresses or to assist waiters or waitresses.

These serving robots usually have a function of receiving food orders or performing serving according to the orders, and may also autonomously drive using table location information, etc. Such serving robots may include a unit of transportation (including a sensor for avoiding obstacles), a display unit for outputting menus or accepting orders, etc.

In addition, the robot may include a unit for arranging or transporting food or food containers.

Meanwhile, the conventional serving robot control algorithm is set to load ordered food from a table and transport the ordered food to the corresponding table, and returns to an original return point when customers at the corresponding table receive the food loaded on the serving robot.

In addition, the conventional serving robot control algorithms include a function of detecting collisions during the movement of the serving robot and preventing accidents. For example, the conventional serving robot control algorithms use a method of detecting collisions through separate sensors (a bumper switch sensor, etc.) mounted on an outside of the robot and braking the robot.

The method has a limitation in detecting only an area on which the separate sensor is mounted. In addition, the method involves detecting a collision based on the presence or absence of contact and position displacement of the switch sensor after the collision, making it difficult to detect dynamics such as sliding or external forces after a collision.

As a result, when a plurality of separate sensors for collision detection are installed on a robot, frequent stopping occurs when the sensors fail, and it is difficult to respond to collisions that occur in areas other than the area on which the sensors are installed, and therefore store users go through the inconvenience of checking and responding to collision exceptions.

Therefore, there is a demand in the art for a method of collision detection braking control in a serving robot that enables accurate detection and has a low failure rate when a serving robot detects collisions. In this regard, Korean Laid-Open Patent No. 10-2023-0084970 discloses a method and system for controlling serving robots.

### SUMMARY OF THE INVENTION

The present invention is directed to providing a method, an apparatus, and a program for collision detection braking control in a serving robot.

However, aspects of the present invention are not restricted to those set forth herein. The above and other aspects of the present invention will become more apparent to one of ordinary skill in the art to which the present invention pertains by referencing the detailed description of the present invention given below.

According to an aspect of the present invention for solving the above-described problems, a method of collision detection braking control in a serving robot is disclosed. The method includes: acquiring sensitivity and a braking time related to collision detection of a serving robot; determining collision detection reference values for each movement state based on the sensitivity; monitoring the movement state of the serving robot and a motor current value of the serving robot; and controlling the serving robot to brake for the braking time when the motor current value exceeds the collision detection reference value corresponding to the movement state.

The determining of the collision detection reference values for each movement state based on the sensitivity may include determining a plurality of collision detection reference values corresponding to each of a forward state, a rearward state, a left turn state, and a right turn state of the serving robot based on the sensitivity.

The monitoring of the movement state of the serving robot and the motor current value of the serving robot may include: receiving two motor current values from a motor driver module related to each of two wheels provided in the serving robot; and monitoring whether each of the two motor current values exceeds the collision detection reference value corresponding to the movement state of the serving robot a preset number of times.

The monitoring of whether each of the two motor current values exceeds the collision detection reference value corresponding to the movement state of the serving robot the preset number of times may include: immediately after the computing device recognizes that at least one of the two motor current values exceeds the collision detection reference value once, when the computing device recognizes that a specific motor current value recognized as exceeding the value once is less than or equal to the collision detection reference value, recognizing that the serving robot has not collided with anything; or immediately after the computing device recognizes that at least one of the two motor current values exceeds the collision detection reference value once, when the computing device recognizes that the specific motor current value recognized as exceeding the value once exceeds the collision detection reference value, recognizing that the serving robot has collided with something.

The method may further include: in the monitoring of the movement state, receiving sensing data related to obstacle recognition from the serving robot and monitoring whether an obstacle exists in a movement direction of the serving robot; when it is recognized that there is an obstacle in a movement direction of the serving robot, recognizing a type of the obstacle based on the sensing data; and determining whether to adjust the sensitivity based on the type of the obstacle.

The method may further include: prior to the monitoring of the movement state, recognizing a plurality of areas included in a space in which the serving robot performs serving; determining a variable sensitivity area among the plurality of areas; in the monitoring of the movement state, monitoring whether a current position of the serving robot corresponds to the variable sensitivity area; adjusting the sensitivity based on a type of the variable sensitivity area when the current position of the serving robot corresponds to the variable sensitivity area; and after adjusting the sensitivity, restoring the adjusted sensitivity when the current position of the serving robot deviates from the variable sensitivity area.

The determining of the variable sensitivity area among the plurality of areas may include: recognizing a current congestion level based on at least one of a current time, the number of orders placed in the space, and the number of people who have entered the space; recognizing at least one area corresponding to the current congestion level among the plurality of areas; and adjusting a size of the at least one area based on the current congestion level to acquire the variable sensitivity area, and the variable sensitivity area may be an area in which the sensitivity related to the collision detection of the serving robot increases.

The determining of the variable sensitivity area among the plurality of areas may include: acquiring map information on the space in which the serving robot performs the serving; recognizing at least one area in which no people move among the plurality of areas based on the map information; and acquiring the at least one area as the variable sensitivity area, and the variable sensitivity area may be an area in which the sensitivity related to the collision detection of the serving robot decreases.

According to an aspect of the present invention for solving the above-described problem, an apparatus is disclosed. The apparatus includes: a memory configured to store one or more instructions; and a processor configured to execute the one or more instructions stored in the memory, in which the processor may perform the above-described methods by executing the one or more instructions.

Another aspect of the present disclosure provides a computer-readable recording medium. The computer-readable recording medium may provide a surgery simulation method in combination with a computer which is hardware.

Other detailed content of the present invention is described in a detailed description and illustrated in the drawings.

### BRIEF DESCRIPTION OF DRAWINGS

FIG. 1 is a diagram illustrating a system according to an embodiment of the present invention.

FIGS. 2 and 3 are exemplary diagrams illustrating a serving robot applicable to various embodiments.

FIG. 4 is a diagram illustrating a hardware configuration of a computing device performing a method of collision detection braking control in a serving robot according to an embodiment of the present invention.

FIGS. 5 to 9 are diagrams for describing an example of the method of collision detection braking control in a serving robot according to an embodiment of the present invention.

### DETAILED DESCRIPTION OF EXEMPLARY EMBODIMENTS

Hereinafter, various embodiments will be described with reference to the drawings. In this specification, various descriptions are presented to provide an understanding of the invention. However, it is obvious that these embodiments may be practiced without these specific descriptions.

The terms “component,” “module,” “system,” etc., used herein refer to a computer-related entity, hardware, firmware, software, a combination of software and hardware, or an implementation of software. For example, the component may be, but is not limited to, a procedure running on a processor, a processor, an object, an execution thread, a program, and/or a computer. For example, both an application running on a computing device and the computing device may be a component. One or more components may reside within a processor and/or execution thread. One component may be localized within one computer. One component may be distributed between two or more computers. In addition, these components may be executed from various computer-readable media having various data structures stored therein. Components may communicate via local and/or remote processes (e.g. data from one component interacting with other components in a local system and a distributed system and/or data transmitted to other systems via networks such as the Internet according to signals), for example according to signals with one or more data packets.

In addition, the term “or” is intended to mean an inclusive “or,” not an exclusive “or.” That is, unless otherwise specified or clear from context, “X uses A or B” is intended to mean one of the natural implicit substitutions. That is, “X uses A or B” may apply to any of the cases when X uses A; X uses B; or X uses both A and B. In addition, the term “and/or” used herein should be understood to refer to and include all possible combinations of one or more of the related items listed.

In addition, the terms “include” and/or “including” should be understood to mean that the corresponding feature and/or component is present. However, the terms “include” and/or “including” should be understood as not excluding the presence or addition of one or more other features, components and/or groups thereof. In addition, unless otherwise specified or the context clearly indicates a singular form, the singular form in the present specification and in the claims should generally be construed to mean “one or more.”

In addition, those skilled in the art should recognize that various illustrative logical blocks, configurations, modules, circuits, means, logic, algorithms, and steps described in connection with the embodiments disclosed herein may be implemented by electronic hardware, computer software, or a combination of both. To clearly illustrate interchangeability of hardware and software, various illustrative components, blocks, configurations, means, logics, modules, circuits, and steps have been described above generally in terms of their functionality. Whether such functionality is implemented by hardware or software will depend on the specific application and design constraints imposed on the overall system. Those skilled in the art may implement the described functionality in a variety of ways for each specific application. However, such implementation determinations should not be construed as departing from the scope of the present invention.

The description of the presented embodiments is provided to enable those skilled in the art to make or use the present invention. Various modifications to these embodiments will be apparent to those skilled in the art. The general principles defined herein may be applied to other embodiments without departing from the scope of the invention. Therefore, the present invention is not limited to the embodiments presented herein. The present invention should be interpreted in the broadest scope consistent with the principles and novel features presented herein.

In this specification, a computer is any kind of hardware devices including at least one processor, and can be understood as including a software configuration which is operated in the corresponding hardware device according to the embodiment. For example, the meaning of “computer” may be understood to include all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some steps can also be performed on different devices.

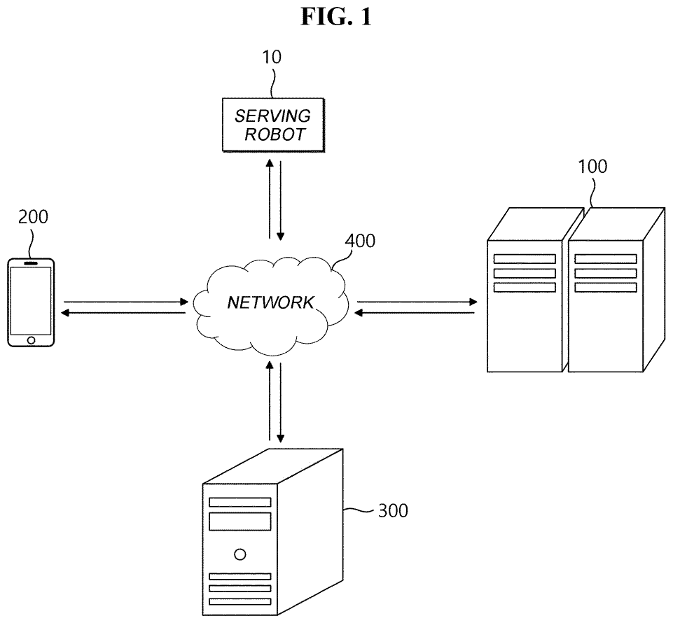

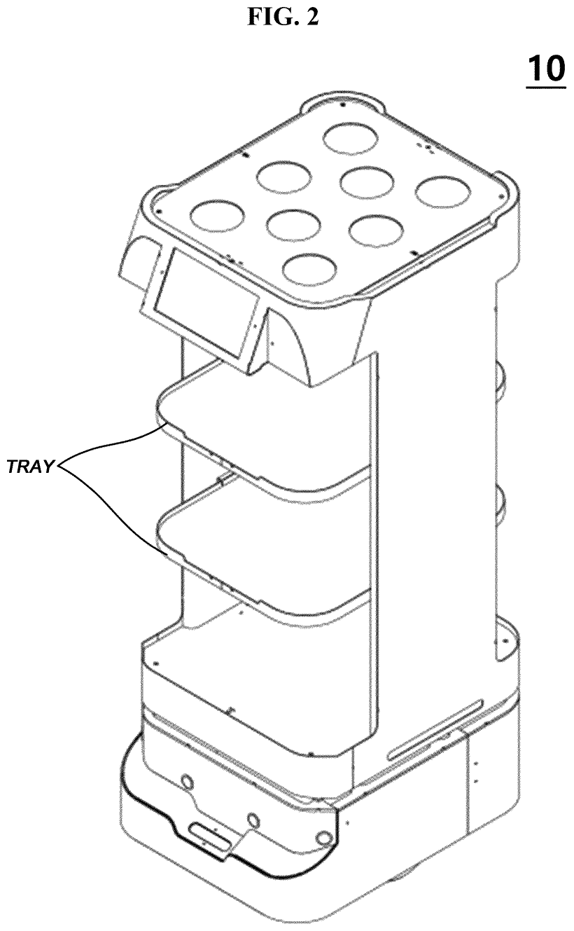

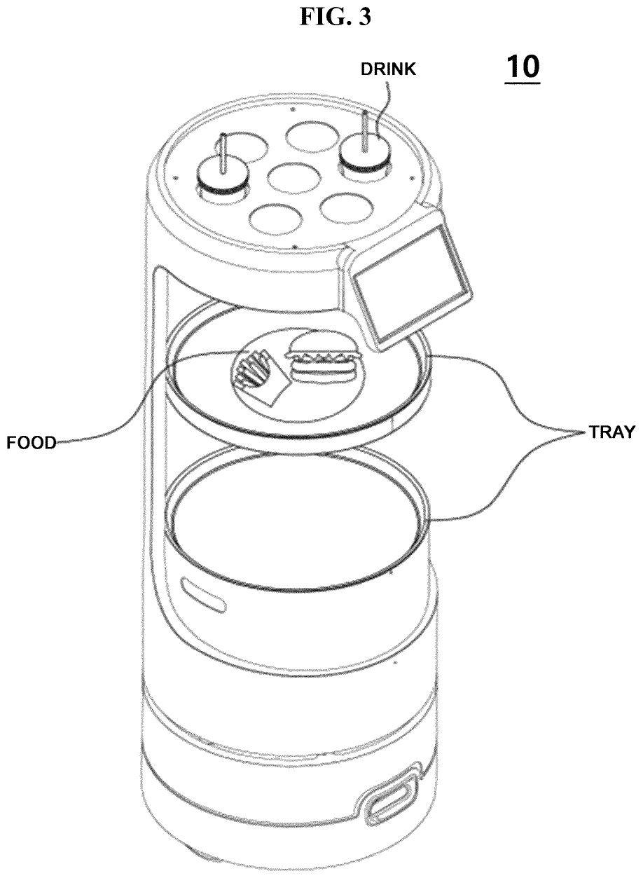

FIG. 1 is a diagram illustrating a system according to an embodiment of the present invention. FIGS. 2 and 3 are exemplary diagrams illustrating a serving robot applicable to various embodiments.

Referring to FIG. 1, the system according to the embodiment of the present invention may include a serving robot 10, a computing device 100, a user terminal 200, and an external server 300. Here, the system illustrated in FIG. 1 is according to an embodiment, and components of the system are not limited to the embodiment illustrated in FIG. 1, and may be added, changed, or omitted as necessary.

In an embodiment, the computing device 100 may control various operations of the serving robot 10. For example, the computing device 100 may be connected to the serving robot 10 through a network 400, and may determine a control command (e.g., a control command for instructing movement along a specific path, a control command for instructing waiting for a predetermined time, and a control command for instructing returning to a preset return point, etc.) for controlling the operation of the serving robot 10, and may control the operation of the serving robot 10 according to the determined control command.

In an embodiment, the computing device 100 may perform a method of collision detection braking control in a serving robot.

Specifically, the computing device 100 may acquire sensitivity and braking time related to collision detection of the serving robot 10. In addition, the computing device 100 may determine collision detection reference values for each movement state based on the sensitivity. In addition, the computing device 100 may monitor the movement state of the serving robot 10 and a motor current value of the serving robot 10. In addition, the computing device 100 may control the serving robot 10 to brake for the braking time when the motor current value exceeds the collision detection reference value corresponding to the movement state.

For example, the computing device 100 may determine a plurality of collision detection reference values corresponding to each of a forward state, a rearward state, a left turn state, and a right turn state of the serving robot 10 based on the sensitivity. The computing device 100 may recognize that a collision has occurred when the motor current value of the serving robot 10 exceeds the reference value according to the current movement state of the serving robot 10, and control the serving robot 10 to brake for a pre-acquired braking time.

Therefore, the computing device 100 of the present invention may detect a collision using the motor current value of the serving robot 10, and prevent inconvenience due to the failure of the separate sensor (e.g., a bumper switch sensor).

In addition, the computing device 100 of the present invention may determine individual reference values according to the movement state (e.g., forward, rearward, left turn, and right turn) of the serving robot 10, thereby enabling more detailed collision detection and reducing misrecognition of collisions.

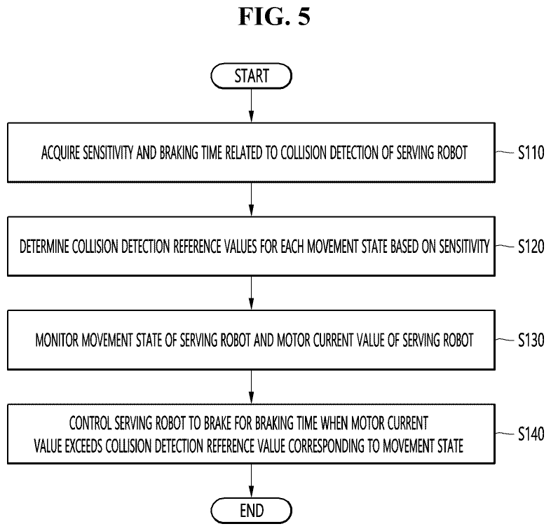

Hereinafter, an example in which the computing device 100 provides the method of collision detection braking control in a serving robot will be described with reference to FIGS. 5 to 9.

In an embodiment, the serving robot 10 may operate according to a control command acquired from the computing device 100. Here, the serving robot 10 may be implemented in a form that transports food to a specific table according to the control command acquired from the computing device 100. For example, the serving robot 10 may include a tray for loading food as illustrated in FIGS. 2 and 3, and may be implemented in a movable form, such as including wheels (not illustrated) at the bottom, but is not limited thereto.

In various embodiments, the serving robot 10 may include a sensor module (not illustrated).

The sensor module may generate sensor data by scanning an area near the serving robot 10. For example, the sensor module may include a camera sensor that generates image data by performing image capturing in a direction in which the serving robot 10 is moving.

In addition, the sensor module may further include a weight measurement sensor that measures a weight value of the tray of the serving robot 10. However, the present invention is not limited thereto.

In an embodiment, the user terminal 200 may be connected to the computing device 100 through the network 400, and may receive a user interface (UI) from the computing device 100.

The user may receive various types of information (e.g., braking status due to the collision detection of the serving robot 10, operation status of the serving robot 10, control results of the serving robot 10 such as the driving path, etc.) through the UI provided through the computing device 100.

In addition, the user may directly control the serving robot 10 through the UI provided through the computing device 100.

Here, the user terminal 200 may be a terminal of a manager (e.g., a store user), but is not limited thereto, and may be a device (e.g., a point of sale system (POS) installed at the store counter, etc.) installed in the store.

In addition, here, the user terminal 200 may be any type of entity(s) in the system that has a mechanism for communication with the computing device 100. For example, the user terminal 200 may include a personal computer (PC), a notebook, a mobile terminal, a smart phone, a tablet personal computer (tablet PC), a wearable device. etc., and may include all types of terminals that may access wired/wireless networks. In addition, the user terminal 200 may include any computing device implemented by at least one of an agent, an application programming interface (API), and a plug-in. In addition, the user terminal 200 may include an application source and/or a client application.

In an embodiment, the external server 300 is connected to the computing device 100 through the network 400, and may store and manage information and data required for the computing device 100 to perform various processes, or may receive, store, and manage information and data generated as the computing device 100 performs various processes. For example, the external server 300 may be a storage server separately provided outside the computing device 100, but is not limited thereto.

In an embodiment, the network 400 may be a connection structure capable of exchanging information between respective nodes such as a plurality of terminals and servers. For example, the network 400 may include a LAN, a WAN, the Internet (World Wide Web (WWW)), a wired/wireless data communication network, a telephone network, a wired/wireless television communication network, a controller area network (CAN), Ethernet, or the like.

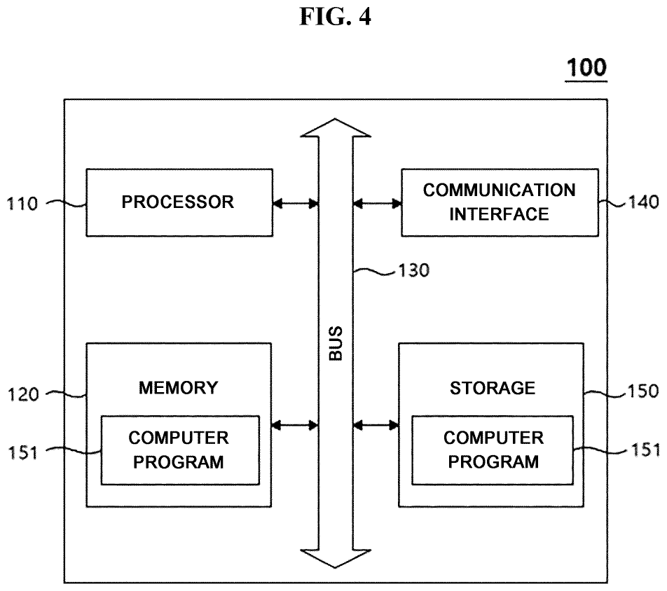

Examples of the wireless data communication network may include 3G, 4G, 5G, 3^{rd} Generation Partnership Project (3GPP), 5^{th} Generation Partnership Project (5GPP), Long Term Evolution (LTE), World Interoperability for Microwave Access (WiMAX), Wi-Fi, Internet, a local area network (LAN), a wireless LAN (WLAN), a wide area network (WAN), a personal area network (PAN), radio frequency, a Bluetooth network, a near-field communication (NFC) network, a satellite broadcast network, an analog broadcast network, a digital multimedia broadcasting (DMB) network, and the like, but are not limited thereto. Hereinafter, a hardware configuration of the computing device 100 will be described with reference to FIG. 4.

FIG. 4 is a diagram illustrating a hardware configuration of a computing device performing a method of collision detection braking control in a serving robot according to an embodiment of the present invention.

Referring to FIG. 4, according to various embodiments, the computing device 100 according to an embodiment of the present invention may include one or more processors 110, a memory 120 that loads a computer program 151 executed by the processor 110, a bus 130, a communication interface 140, and a storage 150 that stores the computer program 151. Here, only the components related to the embodiment of the present invention are illustrated in FIG. 4. Accordingly, those skilled in the art to which the present invention pertains may understand that general-purpose components other than those illustrated in FIG. 4 may be further included.

The processor 110 controls an overall operation of each component of the computing device 100. The processor 110 may include a central processing unit (CPU), a micro processor unit (MPU), a micro controller unit (MCU), a graphics processing unit (GPU), or any type of processor well known in the art of the present invention.

In addition, the processor 110 may perform an operation on at least one application or program for executing the method according to the embodiments of the present invention, and the computing device 100 may include one or more processors.

In various embodiments, the processor 110 may further include a random access memory (RAM) (not illustrated) and a read-only memory (ROM) (not illustrated) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various types of data, commands, and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present invention is not limited thereto.

The bus 130 provides a communication function between the components of computing device 100. The bus 130 may be implemented as various types of buses, such as an address bus, a data bus, and a control bus.

The communication interface 140 supports wired/wireless Internet communication of the computing device 100. In addition, the communication interface 140 may support various communication manners other than the Internet communication. To this end, the communication interface 140 may include a communication module well known in the art of the present invention. In some embodiments, the communication interface 140 may be omitted.

The storage 150 may non-temporarily store the computer program 151. When performing the method of collision detection braking control in a serving robot through the computing device 100, the storage 150 may store various types of information necessary to provide the method of collision detection braking control in a serving robot.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions for performing the method of collision detection braking control in a serving robot, in which the method includes determining the collision detection reference values for each movement state based on the sensitivity, monitoring the movement state of the serving robot 10 and the motor current value of the serving robot 10, and controlling the serving robot 10 to brake for the braking time when the motor current value exceeds the collision detection reference value corresponding to the movement state.

Operations of the method or algorithm described with reference to the embodiment of the present invention may be directly implemented in hardware, in software modules executed by hardware, or in a combination thereof. The software module may reside in a RAM, a ROM, an erasable programmable ROM (EPROM), an electrically erasable programmable ROM (EEPROM), a flash memory, a hard disk, a removable disk, a compact disc ROM (CD-ROM), or in any form of computer-readable recording media known in the art to which the invention pertains.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, or assembler, including various algorithms implemented in a combination of data structures, processes, routines, or other programming constructions. Functional aspects may be implemented in algorithms executed on one or more processors. Hereinafter, the method of collision detection braking control in a serving robot performed by the computing device 100 will be described with reference to FIGS. 5 to 9.

FIGS. 5 to 9 are diagrams for describing an example of the method of collision detection braking control in a serving robot according to an embodiment of the present invention.

Referring to FIG. 5, the computing device 100 may acquire the sensitivity and braking time related to the collision detection of the serving robot 10 (S110).

In the present invention, the sensitivity refers to the sensitivity of the collision detection in the serving robot 10, and may include, for example, a sensitivity value of 0 to 10. That is, when the sensitivity is 0, no collisions may be detected, and when the sensitivity is 10, all collisions may be detected.

In the present invention, the braking time may refer to the time for stopping the serving robot 10 when a collision is detected in the serving robot 10.

For example, the user may determine the sensitivity according to the location or situation in which the serving robot 10 is used, and may transmit the determined sensitivity to the computing device 100 using the user terminal 200. In addition, the user may determine the braking time (e.g., 30 seconds, 1 minute, etc.) depending on the location or situation in which the serving robot 10 is used, and transmit the determined braking time to the computing device 100 using the user terminal 200.

The computing device 100 may determine collision detection reference values for each movement state based on the sensitivity (S120).

In detail, the computing device 100 may determine the plurality of collision detection reference values corresponding to each of the forward state, rearward state, left turn state, and right turn state of the serving robot 10 based on the sensitivity.

For example, the computing device 100 may calculate a constant corresponding to the sensitivity and a normal motor current value for each movement state of the serving robot 10 to determine the collision detection reference values for each movement state of the serving robot 10.

For example, when the sensitivity is 1, the corresponding constant may be preset to 2, when the sensitivity is 2, the corresponding constant may be preset to 1.9, when the sensitivity is 3, the corresponding constant may be preset to 1.8, when the sensitivity is 4, the corresponding constant may be preset to 1.7, when the sensitivity is 5, the corresponding constant may be preset to 1.6, when the sensitivity is 6, the corresponding constant may be preset to 1.5, when the sensitivity is 7, the corresponding constant may be preset to 1.4, when the sensitivity is 8, the corresponding constant may be preset to 1.3, when the sensitivity is 9, the corresponding constant may be preset to 1.2, and when the sensitivity is 10, the corresponding constant may be preset to 1.1. That is, the constant corresponding to the sensitivity may be set to have a size inversely proportional to the sensitivity value. Exceptionally, when the sensitivity is 0, the corresponding constant may be 0.

In this case, the computing device 100 may multiply the constant corresponding to the sensitivity acquired in operation S110 by the normal motor current values for each movement state of the serving robot 10 to determine the collision detection reference values for each movement state of the serving robot 10.

According to an embodiment, the serving robot 10 may include two main wheels that receive power from the motor and two auxiliary wheels to which separate power is not transmitted. Here, when each of the two main wheels included in the serving robot 10 rotates in the same direction, the serving robot 10 may move forward or rearward.

In addition, when the rotation amount of one of the two main wheels included in the serving robot 10 is greater than that of the other main wheel, the serving robot 10 may turn left or right with the other main wheel as an axis. In addition, when the two main wheels included in the serving robot 10 rotate in opposite directions, the serving robot 10 may turn left or right in place.

That is, due to the characteristics of the main wheels that receive power from the motors in the serving robot 10, the torque of each motor of the main wheels may be different depending on the forward state, the rearward state, the left turn state, and the right turn state.

Accordingly, the present invention may determine the plurality of collision detection reference values for each of the forward state, rearward state, left turn state, and right turn state of the serving robot 10. Here, the collision detection reference value may be related to the motor current value.

In an embodiment, since the torque of the motor is calculated as the product of the motor torque constant and the current, the torque and the current may have a linear relationship. Accordingly, the present invention can monitor the motor current value of the motor provided in the serving robot 10 in order for the serving robot 10 to detect the collision.

The computing device 100 may monitor the movement state of the serving robot 10 and the motor current value of the serving robot 10 (S130).

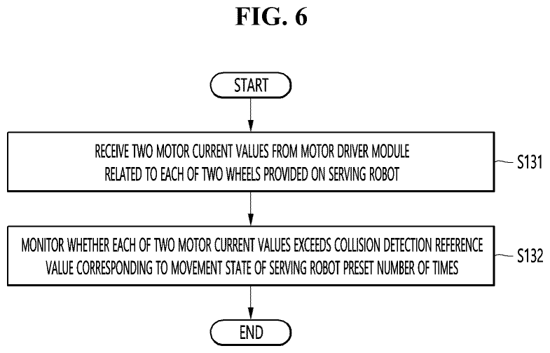

Specifically, referring to FIG. 6, the computing device 100 may receive two motor current values from the motor driver module associated with each of the two wheels provided on the serving robot 10 (S131).

The computing device 100 may monitor whether each of the two motor current values exceeds the collision detection reference value corresponding to the movement state of the serving robot 10 a preset number of times (S132).

For example, immediately after the computing device 100 recognizes that at least one of the two motor current values exceeds the collision detection reference value once, when the computing device 100 recognizes that a specific motor current value recognized as exceeding the value once is less than or equal to the collision detection reference value, the computing device 100 may recognize that the serving robot 10 has not collided with anything.

As another example, immediately after the computing device 100 recognizes that at least one of the two motor current values exceeds the collision detection reference value once, when the computing device 100 recognizes that the specific motor current value recognized as exceeding the value once exceeds the collision detection reference value, the computing device 100 may recognize that the serving robot 10 has collided with something.

Referring back to FIG. 5, the computing device 100 may control the serving robot 10 to brake for the braking time when the motor current value exceeds the collision detection reference value corresponding to the movement state (S140).

Specifically, immediately after it is recognized that at least one of the two motor current values exceeds the collision detection reference value once, when it is recognized that the specific motor current value recognized as exceeding the value once exceeds the collision detection reference value, the computing device 100 may control the serving robot 10 to brake for the braking time.

According to various embodiments of the present invention, the computing device 100 may adjust the sensitivity according to the type of the obstacle when an obstacle exists in a movement direction of the serving robot 10. That is, the computing device 100 may detect the collision of the serving robot 10 using the reference value corresponding to the sensitivity adjusted according to the type of the obstacle.

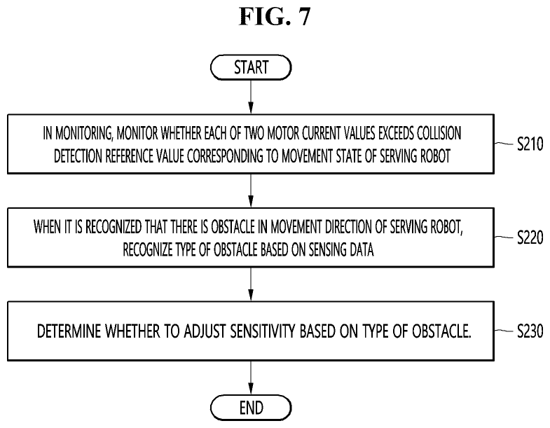

Specifically, referring to FIG. 7, the computing device 100 may receive sensing data related to the obstacle recognition from the serving robot 10 in the monitoring operation S130 of FIG. 5 to monitor whether an obstacle exists in the movement direction of the serving robot 10 (S210).

For example, the serving robot 10 may include at least one sensor for performing sensing in the movement direction. Here, the sensor may include, but is not limited to, a vision sensor, an ultrasonic sensor, an infrared sensor, a laser scanner, and an optical flow sensor.

Meanwhile, when the computing device 100 receives the sensing data measured through the sensor provided in the serving robot 10 from the serving robot 10, the computing device 100 may recognize whether there is an obstacle based on the sensing data.

When the computing device 100 recognizes that an obstacle exists in the movement direction of the serving robot 10, the computing device 100 may recognize the type of the obstacle based on the sensing data (S220).

In the present invention, the type of the obstacle may include a first type in which the serving robot 10 brakes when the serving robot 10 detects the collision related to the corresponding obstacle, and a second type in which the serving robot 10 does not brake when the serving robot 10 detects the collision related to the corresponding obstacle.

For example, the computing device 100 may recognize the type, state, etc., of the obstacle based on the sensing data, and recognize whether the type corresponds to one of the first type and the second type.

For example, the computing device 100 may recognize that the type of the obstacle is a first type when the type of the obstacle is a person, and may recognize that the type of the obstacle is a second type when the type of the obstacle is an electric line on the floor.

The computing device 100 may determine whether to adjust the sensitivity based on the type of the obstacle (S230). As described above, the type of the obstacle may include the first type in which the serving robot 10 brakes when the serving robot 10 detects the collision related to the corresponding obstacle, and the second type in which the serving robot 10 does not brake when the serving robot 10 detects the collision related to the corresponding obstacle.

Specifically, it may be determined that the computing device 100 does not adjust the sensitivity when the type of the recognized obstacle is the first type, and adjusts the sensitivity when the type of the obstacle is the second type.

For example, when the type of the recognized obstacle is the second type for which the serving robot 10 does not brake upon detecting a collision related to the obstacle, the computing device 100 may control the serving robot 10 not to detect the collision due to the obstacle by lowering the sensitivity. In other words, the computing device 100 may control the serving robot 10 not to detect the collision due to the obstacle by increasing the reference value detected as the collision.

Therefore, the computing device 100 of the present invention may prevent the collision detection due to an obstacle that may be ignored, thereby preventing the unnecessary braking of the serving robot 10 and furthermore increasing the serving efficiency of the serving robot 10.

According to various embodiments of the present invention, the computing device 100 may determine a variable sensitivity area among a plurality of areas included in the space in which the serving robot 10 performs serving, and detect the collision of the serving robot 10 using the reference value corresponding to the variable sensitivity when the serving robot 10 is located in the area.

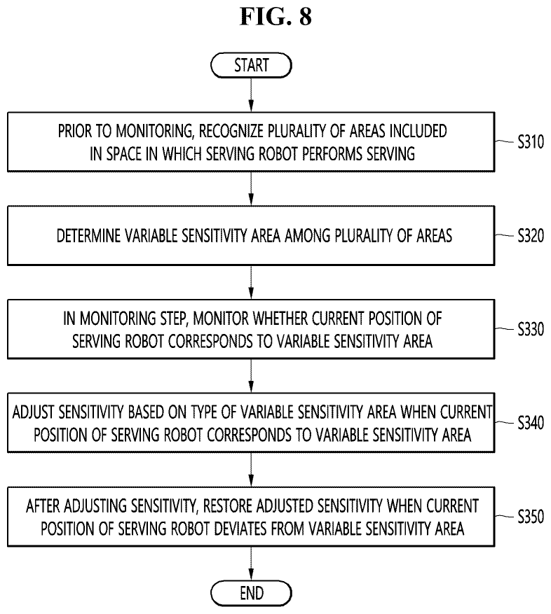

Specifically, referring to FIG. 8, prior to the monitoring operation S130 of FIG. 5, the computing device 100 may recognize a plurality of areas included in the space in which the serving robot 10 performs serving (S310). Then, the computing device 100 may determine the variable sensitivity area among the plurality of areas (S320).

In various embodiments, the computing device 100 may determine the variable sensitivity area based on the congestion level. Here, the congestion level may be a metric used to evaluate a congestion situation of the space in which the serving robot 10 operates (e.g., a restaurant).

In an embodiment, the computing device 100 may recognize the current congestion level based on at least one of the current time, the number of orders placed in the space, and the number of people who have entered the space.

Specifically, the computing device 100 may determine at least one of a first indicator corresponding to the time at which the serving robot 10 performs serving, a second indicator corresponding to the number of orders placed in the space, and a third indicator corresponding to the number of people who have entered the space, and determine the current congestion level based on the determined indicator.

For example, the computing device 100 may apply different values related to the first indicator depending on a preset time period. In detail, for example, the computing device 100 may apply, as the values related to the first indicator, 1 point to a morning time period, 2 points to a time period from noon to 6 p.m., 3 points to a time period from 6 p.m. to 8 p.m., and 2 points to a time period from 8 p.m. to midnight.

In addition, the computing device 100 may apply different values related to the second indicator corresponding to the number of orders placed in the space depending on the number of workers working in the space. In detail, for example, the computing device 100 may apply, as the values related to the second indicator, 1 point to a number of orders corresponding to 1 times the number of workers or more but less than 2 times the number of workers, 2 points to a number of orders corresponding to 2 times the number of workers or more but less than 3 times the number of workers, 3 points to a number of orders corresponding to 3 times the number of workers or more but less than 4 times the number of workers, and 4 points to a number of orders corresponding to 4 times the number of workers or more.

In addition, the computing device 100 may apply different values related to the third indicator corresponding to the number of people who have entered the space depending on the total number of seats provided in the space. In detail, for example, the computing device 100 may apply, as the values related to the third indicator, 1 point to a number of people corresponding to less than 30% of the total number of seats provided in the space, 2 points to a number of people corresponding to 30% or more but less than 60% of the total number of seats provided in the space, 3 points to a number of people corresponding to 60% or more but less than 90% of the total number of seats provided in the space, and 4 points to a number of people corresponding to 90% or more of the total number of seats provided in the space.

In an additional embodiment, a plurality of other serving robots may exist in the space in which the serving robot 10 of the present invention performs serving. In this case, the computing device 100 may collect information for determining the congestion levels from the serving robot 10 and each of the plurality of other serving robots.

For example, the computing device 100 may additionally use an indicator for acquiring images from the serving robot 10 and each of the plurality of other serving robots and calculating the congestion levels based on the number of people or the number of obstacles present within an image having a preset frame size.

In an embodiment, when the computing device 100 determines the scores to be applied to each of the first indicator corresponding to the time for performing the serving, the second indicator corresponding to the number of orders placed in the space, and the third indicator corresponding to the number of people who have entered the space, the computing device 100 may recognize the current congestion level by adding up or averaging the scores related to the first indicator, the second indicator, and the third indicator.

For example, when the computing device 100 adds up the scores corresponding to each indicator, the computing device 100 may recognize the score, which can be calculated, as 3 points to 11 points, and the current congestion level as one of the 9 stages.

Meanwhile, when the computing device 100 recognizes the current congestion level, the computing device 100 may recognize at least one area corresponding to the current congestion level among the plurality of areas. In addition, the computing device 100 may adjust the size of at least one area based on the current congestion level to acquire the variable sensitivity area. Here, the variable sensitivity area may be the area in which the sensitivity related to the collision detection of the serving robot 10 increases. That is, when the serving robot 10 is located in the variable sensitivity area, the computing device 100 may detect the collision of the serving robot 10 using the reference value corresponding to the variable sensitivity.

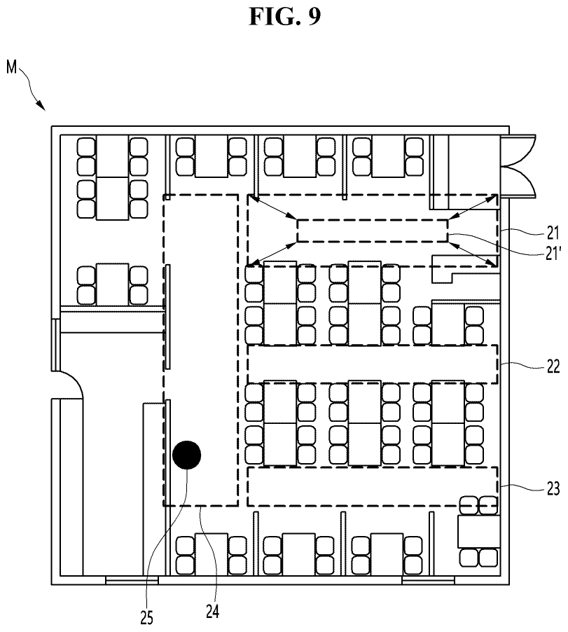

For example, referring to FIG. 9, an example of a plan view M of the space in which the serving robot 10 performs serving is illustrated.

The plan view M of the space in which the serving robot 10 performs serving may include information on a first area 21, a second area 22, a third area 23, a fourth area 24, and a return point 25.

In this case, the computing device 100 may recognize at least one area corresponding to the current congestion level among the first area 21, the second area 22, the third area 23, and the fourth area 24. In addition, the computing device 100 may recognize a constant corresponding to the congestion level, and calculate the constant corresponding to at least one area and the congestion level to adjust the size of at least one area, thereby acquiring the variable sensitivity area.

For example, when the congestion level is 1, the computing device 100 may recognize the first area 21 as at least one area. When the congestion level is 1, the computing device 100 may multiply the size of the first area 21 by the constant corresponding to the congestion level 1 to acquire an area 21′, which is the first area 21 with the size adjusted, as the variable sensitivity area.

As another example, when the congestion level is 2, the computing device 100 may recognize the first area 21 and the second area 22 as at least one area, and multiply the size of each of the first area 21 and the second area 22 by a constant corresponding to the congestion level 2 to acquire the adjusted area as the variable area.

In various embodiments, the computing device 100 may select several areas from among the first area 21, the second area 22, the third area 23, and the fourth area 24 according to a value of a specific indicator included in the congestion level to recognize at least one area. In addition, the computing device 100 may calculate a constant corresponding to a value of at least one area and another specific indicator based on a value of another specific indicator included in the congestion level to adjust the size of at least one area, thereby acquiring the variable sensitivity area.

For example, the computing device 100 may recognize at least one of the first area 21 and the fourth area 24 based on the first indicator corresponding to the time when the serving robot 10 included in the congestion level performs serving.

For example, when the first indicator corresponds to the time zone when many people enter (e.g., from 6 p.m. to 7 p.m.), the computing device 100 may recognize the first area 21 corresponding to an entrance and the fourth area 24 corresponding to a large passage as at least one area.

After recognizing at least one area, the computing device 100 may adjust the size of at least one area based on the second indicator corresponding to the number of orders placed in the serving space included in the congestion level.

For example, while the computing device 100 may recognize the first area 21 corresponding to the entrance and the fourth area 24 corresponding to the large passage as at least one area in the time zone when many people enter, the computing device 100 may adjust the sizes of the first area 21 and the fourth area 24 to be relatively small when the number of orders is less than a preset number to acquire the variable sensitivity area.

Accordingly, the computing device 100 may operate the serving robot 10 safely and efficiently by determining the variable sensitivity area to increase the sensitivity using the indicator or current congestion level considering the current time, the number of orders placed in the space, and the number of people who have entered the space.

In various embodiments, the computing device 100 may acquire the map information on the space in which the serving robot 10 performs serving. In addition, the computing device 100 may recognize at least one area in which no people move among a plurality of areas based on the map information. In addition, the computing device 100 may obtain at least one area as the variable sensitivity area. Here, the variable sensitivity area may be the area in which the sensitivity related to the collision detection of the serving robot 10 decreases. That is, the computing device 100 may control the serving robot 10 not to detect the collision less than a preset level by increasing the reference value detected as the collision.

Accordingly, the computing device 100 may prevent unnecessary braking of the serving robot 10 and efficiently operate the serving robot 10 by determining the area through which no people pass as the variable sensitivity area to lower the sensitivity.

Referring back to FIG. 8, when the computing device 100 determines the variable sensitivity area, in the monitoring operation S130 of FIG. 5, the computing device 100 may monitor whether the current position of the serving robot 10 corresponds to the variable sensitivity area (S330).

When the current position of the serving robot 10 corresponds to the variable sensitivity area (S340), the computing device 100 may adjust the sensitivity based on the type of the variable sensitivity area. Here, the type of the variable sensitivity area may include a first type that increases the set sensitivity and a second type that decreases the set sensitivity, and when the computing device 100 acquires or recognizes the variable sensitivity area, the computing device 100 may recognize one of the first type and the second type.

After adjusting the sensitivity, when the current position of the serving robot 10 deviates from the variable sensitivity area, the computing device 100 may restore the adjusted sensitivity (S350).

As described above, the computing device 100 of the present invention recognizes the area in which the sensitivity is adjusted or varies according to the current situation of the space in which the serving is performed, in the space in which the serving robot 10 performs serving, and when the serving robot 10 is located in the area, the computing device 100 may detect the collision of the serving robot 10 using the reference value corresponding to the adjusted or varying sensitivity.

Therefore, the computing device 100 of the present invention may prevent the unnecessary braking through not only the accurate detection using the motor current value, but also the sensitivity adjustment according to the situation of the serving space, thereby maximizing the serving efficiency of the serving robot 10.

According to a method of collision detection braking control in a serving robot of the present invention, by determining a collision detection reference value according to a movement state based on the sensitivity and monitoring whether the movement state and motor current value of a serving robot exceed a reference value, it is possible to enable the accurate detection and decrease the failure rate.

Effects of the present invention are not limited to the effects described above, and other effects that are not mentioned may be obviously understood by those skilled in the art from the following description.

Although exemplary embodiments of the present invention have been described with reference to the accompanying drawings, those skilled in the art will understand that various modifications and alterations may be made without departing from the spirit or essential features of the present invention. Therefore, it is to be understood that the exemplary embodiments described hereinabove are illustrative rather than being restrictive in all aspects.

What is claimed is:

1. A method of collision detection braking control in a serving robot, which is performed by a computing device including at least one processor, the method comprising:
acquiring sensitivity and a braking time related to collision detection of a serving robot;
determining collision detection reference values for each movement state based on the sensitivity;
monitoring the movement state of the serving robot and a motor current value of the serving robot; and
controlling the serving robot to brake for the braking time when the motor current value exceeds the collision detection reference value corresponding to the movement state.

2. The method of claim 1, wherein the determining of the collision detection reference values for each movement state based on the sensitivity includes determining a plurality of collision detection reference values corresponding to each of a forward state, a rearward state, a left turn state, and a right turn state of the serving robot based on the sensitivity.

3. The method of claim 1, wherein the monitoring of the movement state of the serving robot and the motor current value of the serving robot includes:
receiving two motor current values from a motor driver module related to each of two wheels provided in the serving robot; and
monitoring whether each of the two motor current values exceeds the collision detection reference value corresponding to the movement state of the serving robot a preset number of times.

4. The method of claim 3, wherein the monitoring of whether each of the two motor current values exceeds the collision detection reference value corresponding to the movement state of the serving robot the preset number of times includes:
immediately after the computing device recognizes that at least one of the two motor current values exceeds the collision detection reference value once, when the computing device recognizes that a specific motor current value recognized as exceeding the value once is less than or equal to the collision detection reference value, recognizing that the serving robot has not collided with anything; or
immediately after the computing device recognizes that at least one of the two motor current values exceeds the collision detection reference value once, when the computing device recognizes that the specific motor current value recognized as exceeding the value once exceeds the collision detection reference value, recognizing that the serving robot has collided with something.

5. The method of claim 1, further comprising:
in the monitoring of the movement state, receiving sensing data related to obstacle recognition from the serving robot and monitoring whether an obstacle exists in a movement direction of the serving robot;
when it is recognized that there is an obstacle in a movement direction of the serving robot, recognizing a type of the obstacle based on the sensing data; and
determining whether to adjust the sensitivity based on the type of the obstacle.

6. The method of claim 1, further comprising:
prior to the monitoring of the movement state, recognizing a plurality of areas included in a space in which the serving robot performs serving;
determining a variable sensitivity area among the plurality of areas;
in the monitoring of the movement state, monitoring whether a current position of the serving robot corresponds to the variable sensitivity area;
adjusting the sensitivity based on a type of the variable sensitivity area when the current position of the serving robot corresponds to the variable sensitivity area; and
after adjusting the sensitivity, restoring the adjusted sensitivity when the current position of the serving robot deviates from the variable sensitivity area.

7. The method of claim 6, wherein the determining of the variable sensitivity area among the plurality of areas includes:
recognizing a current congestion level based on at least one of a current time, the number of orders placed in the space, and the number of people who have entered the space;
recognizing at least one area corresponding to the current congestion level among the plurality of areas; and
adjusting a size of the at least one area based on the current congestion level to acquire the variable sensitivity area, and
the variable sensitivity area is an area in which the sensitivity related to the collision detection of the serving robot increases.

8. The method of claim 6, wherein the determining of the variable sensitivity area among the plurality of areas includes:
acquiring map information on the space in which the serving robot performs the serving;
recognizing at least one area in which no people move among the plurality of areas based on the map information; and
acquiring the at least one area as the variable sensitivity area, and
the variable sensitivity area is an area in which the sensitivity related to the collision detection of the serving robot decreases.

9. An apparatus comprising:
a memory configured to store one or more instructions; and
a processor configured to execute the one or more instructions stored in the memory,
wherein the processor performs the method of claim 1 by executing the one or more instructions.

10. A computer program stored in a computer-readable recording medium on which a program for executing a method of collision detection braking control in a serving robot with a computing device is recorded, wherein the method comprises:
acquiring sensitivity and a braking time related to collision detection of a serving robot;
determining collision detection reference values for each movement state based on the sensitivity;
monitoring the movement state of the serving robot and a motor current value of the serving robot; and
controlling the serving robot to brake for the braking time when the motor current value exceeds the collision detection reference value corresponding to the movement state.
